(19) United States
(12) Patent Application Publication
(10) Pub. No.: US 2017/0352288 A1
(43) Pub. Date: Dec. 7, 2017

(54) METHOD AND SYSTEM FOR PHYSICAL TRAINING AND REHABILITATION

(71) Applicant: KONINKLIJKE PHILIPS N.V., EINDHOVEN (NL)

(72) Inventors: Mirela Alina WEFFERS-ALBU, Boukoul (NL); Jan Johannes Gerardus DE VRIES, Leende (NL)

(21) Appl. No.: 15/536,707

(22) PCT Filed: Dec. 8, 2015
(86) PCT No.: PCT/EP2015/078916

§ 371 Date: Jun. 16, 2017

(30) Foreign Application Priority Data
Dec. 19, 2014 (EP) 14199382.4

(51) Int. Cl. G09B 19/00; A61H 3/00; G09B 5/02; A61H 3/04; G06F 19/00

(52) U.S. Cl. CPC G09B 19/003; A61H 3/04; G06F 19/3481; G09B 5/02; A61H 3/00; A61H 2201/5071; A61H 2201/5064; A61H 2201/5061; A61H 2201/5046; A61H 2201/5038; A61H 2201/5092; A61H 2230/06; A61H 2230/50; A61H 2230/80; A61H 2201/5084

(57) ABSTRACT

The present invention relates to a system for assisting a person in walking, comprising a measurement unit for measuring physiological data including vital sign data and movement data of the person; an activity ability determination unit which is configured to determine a frailty state of the person based on the vital sign data, and to determine walking characteristics of the person based on the movement data; an activity program unit which is configured to select and continuously update a walking program based on the determined frailty state of the person and the determined walking characteristics of the person.

### FIELD OF THE INVENTION

The present invention relates to a method and system for physical training and rehabilitation. In particular, the present invention relates to a method and system for assisting a person in walking considering the frailty state and walking characteristics of the person.

### BACKGROUND OF THE INVENTION

Some people, in particular elderly or physically impaired people, need to be kept active but experience difficulty during physical activity. During a physical activity like walking, they are at risk of falling. Such persons need activity programs adjusted to their own walking abilities.

The working abilities depend not only from the age of the person, but also from various disorders which may affect walking abilities to a certain degree and may have particular characteristics. Some disorders may affect only the walking ability, but not the remaining physical constitution of the person. Examples are certain types of dystrophy and myotonia effecting essentially walking/movement ability only. Muscular dystrophies are, for example, a group of muscular diseases that weaken the skeletal muscle system and temper locomotion. Muscular dystrophies are characterized by progressive skeletal muscle weakness, defects in muscle proteins, and a death of muscle cells in tissue. Myotonia is a symptom of certain neuromuscular disorders characterized by delayed relaxation (prolonged contraction) of the skeletal muscles after voluntary contraction or electrical stimulation.

In addition to medical aid of people with hampered walking ability, a number of tools for assistance have been developed. Examples of such tools for disabled or elderly people, who need additional support to maintain balance or stability by walking, are walkers or walking frames. A different approach to the walker is the rollator or wheeled walker. A rollator essentially comprises a frame with three or four wheels, one or more handle bars and usually a built-in seat allowing the user to stop and rest when needed. In general, rollators are more sophisticated than conventional walkers with wheels. They may be adjustable in height and are often more light-weight. The handle bars are equipped with handbrakes that can be lifted or pushed downward to instantly stop the rollator's movement. The brakes can also be used in maneuvering the rollator.

Currently, several approaches have been made to adapt rollators and similar devices more to the needs of elderly and/or impaired persons addressing, for instance, vision impairment and cognitive impairment by including electronics and sensors helping in this respect. In addition data from the external environment are received and evaluated to adapt the behavior of an intelligent walker/rollator.

US 2013/0171599 discloses a system and method to enable a user to favorably coordinate timing of musculo skeletal movement and skeletal muscle contraction and relaxation with the cardiac pumping cycle.

US 2014/0045656 A1 discloses, for example, an exercise equipment having inter alia a processing unit receiving health data of a user. An evaluation module analyzes the health data and provides a respective health status. A feedback module receives the health status and provides an exercise instruction to the exercise equipment based on the health status. Health data are provided by a sensor unit comprising a blood pressure sensor, a body temperature sensor, a heart rate sensor, a body weight sensor, a balancing ability sensor, a bone density sensor, and a hand-grip sensor.

The known systems for assisting a person in walking deal preliminary for obstacle detection and avoidance pass finding and navigation aid, which may lead the person by automatic detection of intended walking direction. There is, however, still a need for an intelligent technology which is used to train elderly and/or disabled persons building up their strength aside from just helping them to navigate. The devices according to the state of the art do not address elderly patients who need to be kept active and experience difficulty in walking being a risk for falling due to various factors, such as physical disability, or general frailty.

### SUMMARY OF THE INVENTION

It is therefore an object of the present invention to provide a system and method for assisting a person in walking which actively assists and trains elderly to build up their strength aside from just helping them to keep balance and to navigate. Another objective of the present invention is the provision of a system and method that aids a person with a personalized activity program. Still another objective of the present invention is the provision of a method and system which is not restricted to a particular group of persons, but may be employed by essentially all elderly people and/or people suffering from walking disabilities. Still another objective is the provision of a system and method which may be effectively used for training diseased persons with impaired walking capability, such as persons having dystrophia and/or myotonia.

In a first aspect of the present invention a system for assisting a person walking is provided. Said system comprises: (i) a measurement unit for measuring physiological data including vital sign data and movement data of the person; (ii) an activity ability determination unit which is configured to determine a frailty state of the person based on the vital sign data, and to determine walking characteristics of the person based on the movement data; and (iii) an activity program unit which is configured to select and continuously update a walking program based on the determined frailty state of the person and the determined walking characteristics of the person.

In a further aspect of the present invention a method for assisting a person walking is provided. Said method comprises the steps of: (i) measuring physiological data including vital sign data and movement data of the person; (ii) determining a frailty state of the person based on the vital sign data; (iii) determining walking characteristics of the person based on the movement data; and (iv) selecting and continuously updating a walking program based on the determined frailty state of the person and the determined walking characteristics of the person.

In still a further aspect of the present invention a computer program is provided. Said program comprises program code means for causing a computer to carry out the steps of the method mentioned above when said computer program is carried out on the computer.

The invention therefore overcomes the above-mentioned disadvantages by providing a system and method which not only takes care of various vital sign data, such as blood pressure, but takes movement characteristics into account as well. Vital sign data and optionally data originating from a patient database are used for calculating the person's frailty state. In addition, walking characteristics of the person are determined based on movement data. This is performed for instance on behalf of data reflecting motion capability, motion sequence, movement patterns, and snapshots thereof. Movement data may include not only information about the person during use of the present system, but also movement data of a person approaching the system to use the same, or even movement data which being monitored when the person performs any other activity which is not connected with the use the present system, such as walking in general. The person may select a walking program which is based on the determined frailty state of the person and the determined walking characteristic of the person. In addition, said walking program is continuously updated, i.e. taking into account the person's instantaneous frailty state and walking characteristics. In this manner the presented system and method provide an effective means for assisting an elderly person and/or disabled person in walking.

Accordingly, the present system and method provides effective walking assistance to train elderly patients/persons and build up their strength by means of personalized walking programs, tailored to their own walking ability. The system and method permits the choice of a walking program based on general health patient data (including vital sign data and movement data), by learning the effects of previous programs on the patient's walking and/or activity ability, and optionally based on environmental data. The system is suitable for essentially elderly patients who need to be kept active and experience difficulties in walking, being at risk for falling due to various factors, such as a physical disability (after health events, such as stroke, and prolonged bed stay in-home), or general frailty.

The present system for assisting a person in walking is not particularly limited and may comprise for instance a walker, a rollator, an exoskeleton, a stick, and a crutch. A rollator is preferred. Such a rollator may comprise three or four wheels, a seat, brakes, and a frame made for instance from aluminum. The system is further equipped with respective electronics and sensors permitting the dedicated use. The system may further have an electrical auxiliary drive for facilitating the person to move the system, such as a rollator. In addition, the system and auxiliary drive may be adapted for facilitating for climbing obstacles, such as a pavement or treads. Accordingly, the system for assisting a person in walking may be also in form of a kit, wherein a measurement unit, an activity ability determination unit, and an activity program unit are provided separately and with which a system, such as a rollator, may be equipped. It will be appreciated that such equipping may be performed by the final user according to manufacturer instructions. The components of the system, i.e. the measurement unit, the activity ability determination unit, and the activity program unit may be comprised in a handheld device, such as a smartphone or tablet computer.

The measurement unit for measuring physiological data may be for instance a measurement unit for measuring vital sign data or a measurement unit for measuring movement data of the person. A suitable measurement unit for measuring physiological data may comprise any kind of physiological data sensor, including e.g. a vital sign camera, a blood pressure sensor, a pressure sensor, an organic skin sensor, a conventional camera, a photosensor, an accelerometer, a pedometer sensor, and a GPS sensor, but is not limited thereto. Accordingly, physiological data as used herein are not dedicated to vital signs only, but also comprise movement data or movement information of the person using the system or of a person who intends to use the system.

Vital signs are used to measure the body's basic functions. These measurements are taken to help assessing the general physical health of a person, and may also give clues about possible diseases and showing a progress towards recovery. The vital signs may include the four primary vital signs: body temperature, blood pressure, pulse (heart rate), and breathing rate (respiratory rate). Examples of sensors for providing vital sign data comprise for instance a temperature sensor, a heart rate sensor, a vital sign camera (i.e. a camera measuring a vital sign based on remote photopletysmography), a blood pressure sensor, a pressure sensor, and a galvanic skin sensor. The data provided by the one or more sensors may be used alone or in combination and/or embedded in different tests, such as, but not limited to, a handgrip test, a blood pressure test, a heart rate test, a test on respiratory syncytial virus (RSP test), and a galvanic skin response test.

The expression “movement data” as used herein refers to any data indicating motion capability, motion sequence, movement patterns and/or snapshots thereof. Accordingly, movement data provide information about how the person using the present system currently moves. Snapshots are dedicated to particular points in time of motion sequence and movement patterns. Such snapshots may for instance reflect the person's capability to lift a foot by providing information about the maximum height of the foot over the ground during walking. Movement data preferably reflect preliminary the movement of the feet, in terms of step size, step height above ground, step speed, regularity of the steps, rolling of the feet, etc., but are not limited thereto. Additionally, movement data may reflect the movement of all the leg including for instance information about the bending angle of different joints, such as the knee or ankle. The movement of the torso and/or arms may also provide important information about walking and walking capability, as movement of the legs necessarily includes also movement of torso and/or arms. Accordingly, this information may be considered as well.

The measurement unit for measuring movement data may include various sensors, such as a camera, a photosensor, an accelerometer, a pedometer sensor, and a GPS sensor. A camera may be a conventional camera following the person's movement and providing a continuous film and/or single pictures. The camera is preferably provided with respective electronics providing evaluation of the person's movement, and allowing following up the person's movement. One or more photosensors, such as five, ten, or 11 to 20 photosensors may be employed. The photosensors may be connected with the frame of the rollator in a manner permitting the provision of signals upon movement of the person using the rollator. The photosensors are preferably present in the form of light barriers. The one or more photosensors may be mounted to the frame in a manner that they provide information about movement of the legs and of the feet, such as step size and step height indicated above. Accelerometer and pedometer sensors are well-known in the art and usually attached to the user, i.e. the user's skin or his/her clothing. Data from such an accelerometer or pedometer sensor are provided to the measurement unit remotely, such as by radio signals, or by wire. GPS sensors are also well-known in the art.

Accordingly, the measurement unit for measuring physiological data including vital sign data and movement data of the person may be connected to at least two sensors, one of them for measuring vital sign data and the other for measuring movement data of the person. It will be appreciated that any number of sensors may be provided. For example, 1 to 10, such as 2 to 9, 3 to 8, 4 to 7 or 5 to 6 vital sign sensors and/or movement sensors may be provided. It is also possible to provide a sensor that delivers both vital sign data and movement data.

The activity ability determination unit is configured to determine the frailty state and the walking characteristics of the person based on the above-mentioned data, i.e. the vital sign data and the movement data.

The expression “frailty” as used herein refers to a common geriatric syndrome embodying an elevated risk of catastrophic declines in health in function among elderly adults. Frailty is preliminary associated with aging, but may also include other factors originating from various diseases, such as chronic hypertension. Frailty may be expressed in terms of scores, for instance any numeric value within a predetermined scale ranging for instance from one to ten. Alternatively, frailty may be expressed in terms of “low, medium, high”.

The term “walking characteristics” as used herein refers to the data exclusively obtained by movement data. Accordingly, walking characteristics of the person refer to data describing motion capability, motion sequence, and movement patterns of the person as indicated above. The walking characteristics may be expressed in terms of scores, for instance any numeric value within a predetermined scale ranging for instance from one to ten. Alternatively, walking characteristic may be expressed in terms of “low, medium, high”.

The activity program unit is further configured to select and continuously update the walking program based on a determined frailty state of the person and a determined walking characteristic of the person. It will be understood that the determined frailty state and/or determined walking characteristics may be weighted. This permits for instance rendering walking characteristics more important than frailty state. In addition, the present system may permit selecting of a walking program not only on behalf of vital signs data and movement data provided by the measurement unit, but also by e.g. manual input and/or patient information from databases. The walking program is furthermore continuously updated, i.e. an update of the walking program in the light of the determined frailty state and the determined walking characteristics of the person is preferably performed in real-time. Accordingly, the present system and method provides at each moment information and optionally indication of the current status of the person and/or about his/her capabilities for walking. The present system and method may further permit estimation/extrapolation of the walking capabilities of the person in future, such as the next five or ten minutes, or even longer times such as up to one hour, two hours, three hours, or even more. Accordingly, the activity program unit may automatically suggest a longer walking route based on a good current condition of the person or a short walking route in the light of a lower condition of the user. In addition, the walking program may be selected and/or updated in view of other parameters, such as preferences of the person, weather report(s), patient history, and combinations thereof. Patient history as used herein may refer to values and trends of the person's frailty state, person's walking characteristics, overall determined activity ability in response to various walking programs used in the past, and medical records. Each of said parameters may be weighted and combined for selecting and/or updating the walking program.

The walking program may be selected and updated on behalf of the above mentioned parameters. The walking program may be further selected on behalf of a route, information about severity of the route, such as information about conditions of the ground and slopes, and estimated time duration. The system may either propose a route to the person. Alternatively, the person may select a route from a number of previous selectable or prestored routes. It is preferred that selection of the walking program is performed on behalf on frailty state and walking characteristics considering particularly past trends, such as development of frailty state and walking characteristics over e.g. the last four weeks, whereas updating is performed in view of current parameters, such as real-time parameters, or parameters which are not older than e.g. five minutes, four minutes, three minutes, two minutes, one minute, or thirty seconds. The walking program may be further influenced and update, such as. the current weather report.

It will be understood that the components of the present system may be in form of any device, such as a handheld device. Preferably, a smartphone or tablet may be used as system for assisting a person in walking. Alternatively, a device, such as a rollator, may be equipped with the components of the present system.

According to one embodiment of the present invention, the system further comprises an activity hardware unit for physically leading and/or supporting the person during the person's execution the walking program, wherein the activity hardware unit is configured to physically lead and/or support a person based on the selected walking program. Accordingly, the activity hardware unit is part of the system or even corresponds to the system. Alternatively or in addition, the activity hardware unit may comprise one or more of the receiving unit, the activity ability determination unit and the activity program unit. Preferably, the activity hardware unit comprises the receiving unit and the activity ability determination unit, or the receiving unit and the activity program unit, or the activity ability determination unit and the activity program unit. More preferably, the activity hardware unit comprises the receiving unit, the activity ability determination unit and the activity program unit.

According to another embodiment of the present invention at least one of the receiving unit, the activity ability determination unit, and the activity program unit are comprised in the activity hardware unit of the present system.

According to still another embodiment of the present invention the measurement unit for measuring vital sign data is composed of at least one physiological data sensor selected from the group consisting of a vital signs camera, a blood pressure sensor, a pressure sensor, and a galvanic skin sensor. It will be appreciated that any number of these sensors may be used alone or in combination. Preferably, the measurement unit comprises a vital sign camera, a blood pressure sensor, a pressure sensor, and a galvanic skin sensor.

The vital signs camera may detect and monitor coughing events frequency as well as incidence of dyspnea (characterized by a respiration amplitude and breathing cycle length). The present of coughing events and dyspnea may contribute for instance to a higher frailty score. Conversely, no coughing event and dyspnea detected contributes to a lower frailty score. The vital signs camera may be used in a respiratory syncytial virus test, wherein the person using or intending to use the present system is tested for respiratory syncytial virus infection.

The vital signs camera may be also used for monitoring the heart rate levels, compare them against medical normal thresholds, and monitor strands. Values outside the boundary of normal medical thresholds as well as high variability in heart rate value trends contribute to a higher frailty score. Conversely, stable trends of values within the conventional boundaries of this parameter contribute to a lower frailty score. The vital signs camera may be used for performing a heart rate test.

The blood pressure sensor may be for instance an optical sensor which is integrated in the handle of the rollator. Alternatively, any other kind of suitable sensor may be used. The blood pressure sensor monitors the blood pressure levels, compares them against medical normal thresholds, and monitors trends. Values outside the boundary of normal medical thresholds, as well high variability blood pressure value trends contribute to a higher frailty score. Conversely, stable trends of values within the normal boundaries of blood pressure values contribute to a lower frailty score. The blood pressure sensor may be used for performing a blood pressure test.

A pressure sensor may be used which is preferably o in form of an air cushion which may be embedded in the handle of a rollator, or alternatively embodied as contact sensors. The pressure sensor detects the pressure level, compares to a threshold and monitor strands. Values lower than threshold contributes to a higher frailty score. Conversely, opposite values of this parameter contribute to a lower frailty score. The pressure sensor may be used performing a grip test.

The galvanic skin sensor may be a galvanic skin response sensor which may be embedded in the rollator handle. The galvanic skin sensor measures skin conductivity levels and trends. Significantly increased galvanic skin response trends within a short period of time indicate stress which overall contributes to a higher frailty score. Conversely, stable trends of values within the normal boundaries of this parameter contribute to a lower frailty score. The galvanic skin response sensor may be used for performing the galvanic skin response test.

An accelerometer may be used for performing a time to get up and go test (TUG) which may be used for detecting and monitoring the time for the person to get up from a chair and to determine the walk speed to reach the system, such as a rollator. Longer time up and lower speed contributes to a higher frailty score. Conversely, opposite values of these parameters contribute to a lower frailty score.

The expression “normal boundaries” are dedicated to conventional health parameters and indicate the range of these parameters for the person using the system. These parameters reflect the person's vital signs under normal conditions. Normal boundaries may refer for instance to a healthy person of the same age as the person using the present system. The normal values of this healthy person for vital sign data and movement data may serve in conjunction with respective thresholds, such as variation of the vital sign data and movement data about ±8%, preferably ±7% or less, such as ±5%, ±3%, ±2%, ±1% or even 0%, as reference values. Accordingly, vital sign data and/or movement data of the person using the present system within the before mentioned ranges may be considered normal.

According to an embodiment of the present invention the measurement unit for measuring movement data is composed of at least one movement data sensor selected from the group consisting of a camera, photosensor, accelerometer, pedometer sensor, and a GPS sensor. As already indicated above, movement data are dedicated to any data describing the movement of the person using the system. These movement data may be collected at any time, independent if the person is using the system or not. For instance and preferably, movement data of the person are collected during approaching the system with the intention to using the same. Accordingly, these data may reflect the current capability of the person to move, and in particular the current capability of the person to walk. The camera may be a conventional camera making a film or single pictures of the person and capable of comparing with a conventional movement profile of the same person or any other person. Significant deviations of movement may contribute to different determined walking characteristics of the person. For instance, higher lifting of the feet, higher step size and faster movement of the feet in comparison to former data of the same person being of any comparative data may indicate good walking characteristics. In the same manner, a lower step size, slow movement of the legs, and lowest step height may indicate low walking characteristics.

A number of photosensors may be employed as well. The photosensors are preferably used in form of light barriers. The photosensors may be attached to the frame of the system and arranged in a pattern permitting determining movement of feet, step size, step height, and walking speed. In the same way like a camera, these values may contribute to good walking characteristics or bad walking characteristics of the person.

An accelerometer may be employed as well. The accelerometer sensor may be alternatively used for measuring the pulse rate signal and the respiration signal, i.e. for providing vital sign data. The accelerometer may be further adapted to provide a corresponding plurality of acceleration signals. The sensor may, for example, comprise a multi-accelerometer which is adapted to generate a movement signal indicative of the acceleration along different spatial axes. The multi-accelerometer is preferably a triaccelerometer adapted to generate a movement signal that comprises three accelerometer signals indicative of acceleration along three orthogonal spatial axes. For example, tri-accelerometers named Bosch BMA355, ST Microelectronics NIS3DSH, ST Microelectronics NIS344LH or Kionics KXM52 can be used. However, also other kinds of multi-accelerometers can be used for generating accelerometer signals indicative of the acceleration along different spatial axes.

Pedometer sensors and GPS sensors are well-known to the skilled person. The pedometer sensor may be, likewise to the accelerometer sensor, be attached to the user and/or to his/her clothing. The signals for the accelerometer and/or pedometer sensor may be transferred to the measurement unit by wire connection, or wirelessly, i.e. remotely. Corresponding techniques from remote transmission are well-known to the skilled person and comprise for example radio transmission. The GPS sensor is preferably attached to the system and provides the current position of the system and permits navigation of the same.

According to another embodiment of the present invention, the system further comprises an input unit for entering preferences of the person and/or a data interface, such as an internet module or other information retrieving module for receiving for instance weather reports, wherein the activity program unit is further configured to take into account preferences of the person and/or weather reports for selecting and continuously updating the walking program. The input unit enables the person using the system or intending to use the same to enter for instance preferences about the walking program. Preferences of the walking program may comprise generic parameters, such as a severity level. Accordingly, the person may choose a program according to his/her form. In addition, the input unit may be used for inputting data from a patient database. The patient database may comprise any health data, including vital sign and/or movement data of the person. Such patient data represent the medical history of the person in view of vital sign data and/or movement data and may be used for further improving accuracy of the system for determining the frailty state and/or walking characteristics.

The data interface, such as an internet module, may take for instance weather reports into account. Such a data interface may be based on any kind of wired or wireless data transmission. This permits selection of a walking program in dependence to the current weather conditions. Accordingly, bad weather may be used for suggesting the person of a walking program with a shorter route. It will be appreciated that any kind of data interface may be used, such as for example an interface receiving short messages with weather information.

According to another embodiment the system further comprises a display unit. The display unit may be used for displaying the walking program and/or updates thereof, the frailty state, and walking characteristics. This may be performed by showing a number indicative for a particular frailty state and/or walking characteristics. I.e. a ranking may be performed. A walking program may be shown to the person intending to use the present system. The walking program may be shown for instance as easy medium, or hard walking program. Accordingly, the person may select a starting walking program according to his/her personal preferences. Upon the walking program is started, the same program is adapted based on a determined frailty state of the person and a determined walking characteristic of a person. In addition, a continuous updating is performed, i.e. updating in real time. The display unit may form part of a handheld device, such as a smartphone or tablet computer of the person using the present system. In addition, the display unit may be other remote unit, such as a display showing a medical practitioner one or more of the person's walking program, frailty state, and walking characteristics.

The display unit may comprise any kind of display means including any kind of optical, tactile, and audible out and combinations thereof. The display may be a screen. The screen of a handheld device, such as a smartphone or tablet computer, is preferred.

According to still another embodiment of the present invention, the system is a walking assistance device or an exoskeleton. A working assistance device may comprise a walker or rollator. A rollator is preferred.

The present method is preferably performed by using the present system. The present method is preferably performed in real-time.

According to one embodiment of the present invention the present method further comprises the step of physically leading and/or supporting the person during the person's execution of the walking program based on the selected and continuously updated walking program.

According to another embodiment of the present invention the step of selecting the walking program is further based on at least one of preferences of the person, and weather reports.

According to still another embodiment of the present invention the step of determining the frailty state of the person comprises performing a test selected from the group consisting of a heart rate test, a respiratory syncytial virus test, a blood pressure test, and a galvanic skin response test. The tests are as defined above.

According to one embodiment of the present invention the step of determining walking characteristics of the person comprises performing a movement test selected from the group consisting of a time up & go test, tremor frequency analysis, movement pattern analysis and a functional movement screen. These tests are known in the art.

### BRIEF DESCRIPTION OF THE DRAWINGS

These and other aspects of the invention will be apparent from and elucidated with reference to the embodiment(s) described hereinafter. In the following drawings

FIG. 1 shows a schematic drawing of a rollator for assisting a person in walking;

FIG. 2 schematically shows the general system execution, i.e. how the method for assisting a person in walking is performed; and

FIG. 3 schematically shows the main features of a system for assisting a person in walking.

### DETAILED DESCRIPTION OF THE INVENTION

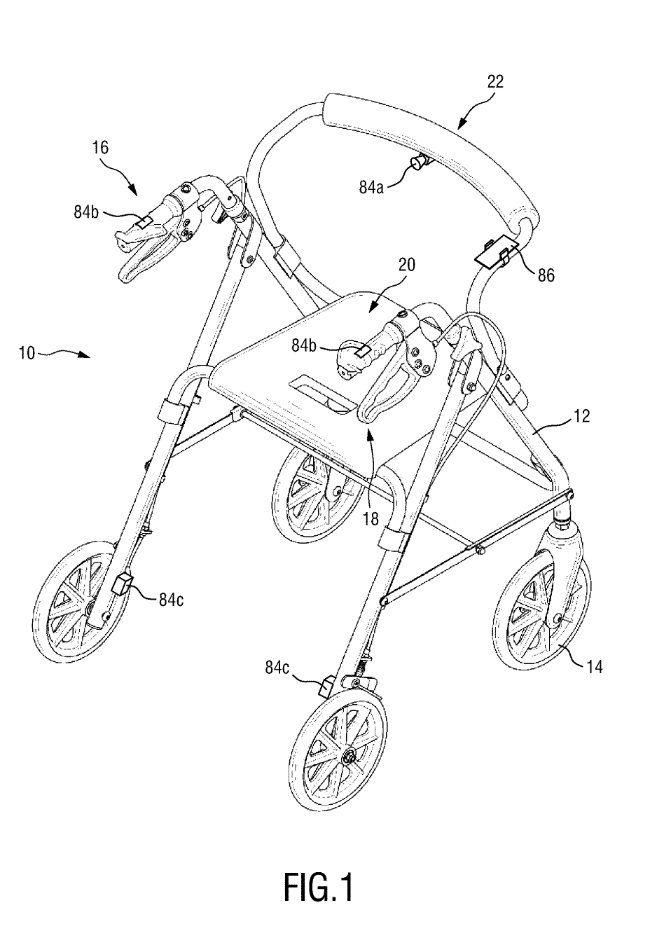

FIG. 1 schematically shows a system 10 for assisting a person in walking. The system according to the shown embodiment is a rollator 10. It will be appreciated that the invention is not limited to a rollator, but on the contrary each kind of system for assisting a person in walking may be comprised, such as another walking assistant device or an exoskeleton.

The rollator 10 comprises a frame 12 and four wheels 14 rotatably mounted thereto. Handles 16 are provided with brakes 18. The rollator 10 further has a seat 20 and back rest 22 permitting the person to take a time out. The rollator may be collapsed for facilitating transport. The rollator may be provided with a number of sensors 80, such as vital signs camera 84a, hand-grip sensors 84b and photosensors 84c. The sensors 80 of the rollator 10 are adapted for wirelessly transmitting physiological data signals to a measurement unit (not shown). The measurement unit may be included in a handheld device and stored in cradle 86.

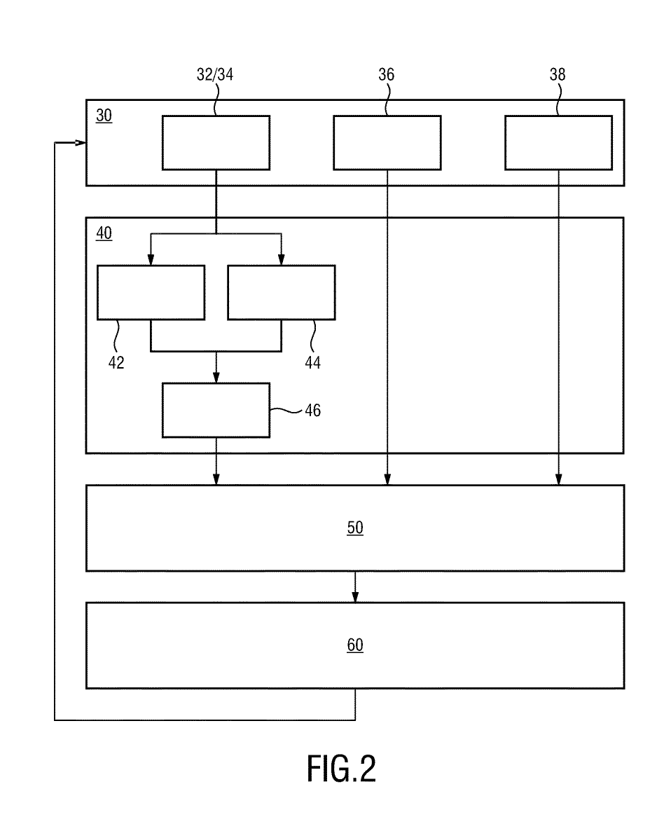

FIG. 2 schematically shows general execution of the present system 10. In a first step 30 data are acquired for measuring physiological data 32, 34, i.e. vital sign data 32 and movement data 34 of the person. At a same stage previous available reports on the person, such as a patient history, may be entered. Also preferences 36 of the person, such as patient itinerary preference data, may be entered by the person using or intending to use the system 10. Additional reports 38 may be received via internet. It will be appreciated that there is no particular restriction about the amount and combination of sensors, input unit and/or data interface. Rather any number of sensors for measuring vital sign data 32 and movement data 34 of the person may be employed. In a next step 40 frailty state 42 of the person based on the vital sign data 32 of the person and walking characteristics 44 of the person based on the movement data 34 are determined. Frailty state 42 and walking characteristics 44 are used for determining activity ability 46. Activity ability 46 data are further used for selecting and continuously updating a walking program 50 based on the determined frailty state 42 of the person and the determined walking characteristic 44 of the person. In the present case, additionally preferences 36 of the person and weather reports 38 have been taken into account for selecting and continuously updating the walking program 50. Thereby, the present system enables in step 60 guiding a patient according to the selecting walking program 50 in view of a number of physiological data not only comprising vital sign data, i.e. data reflecting the current health status of the person, but also walking characteristics, i.e. data reflecting the current capability of the person to walk, patient itinerary preference data and weather reports.

An optional data interface, such as an internet module, for receiving weather reports 38 permits considering of e.g. unfavorable weather. Accordingly, the system 10 may decide that the person should not follow any walking program at all during a particular day. Alternatively, based on a determined frailty state 42 and/or a determined walking characteristic 44 below a minimum threshold, the system 10 may also decide that a person should not follow any walking program at all. The walking program may be characterized by a specific itinerary (that may or not include curves/ground inclined to an angle), (varied) speed, and duration. While the person follows the walking program 50, the system 10 keeps monitoring the patient frailty state 42 and walking characteristics 44, and based on these it updates the walking program 50. If for example the values of the determined frailty state 42 and/or the determined walking characteristics 44 are at a stable or even positively improved, the walking program 50 will be continued. Otherwise, the walking program 50 will be adjusted to meet the current frailty state 42 and/or the current walking characteristics 44.

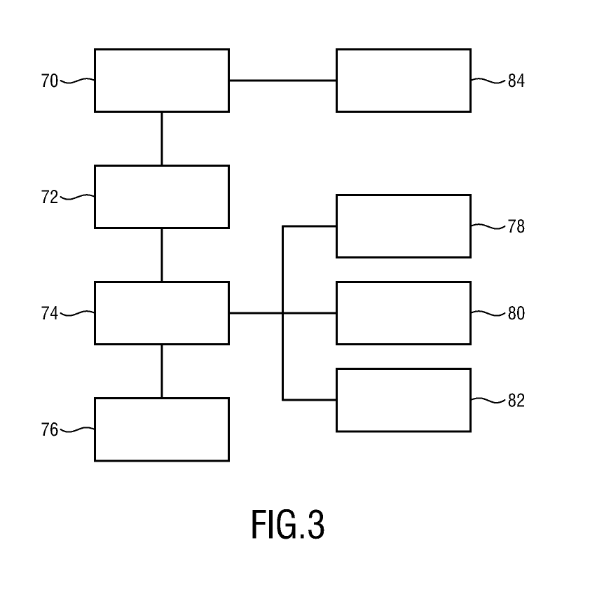

FIG. 3 shows a schematic view of the system 10 for assisting a person in walking. The measurement unit 70 for measuring physiological data 32, 34 including vital sign data 32 and movement data 34 of the person receive sensor signals from a number of sensors, such as a vital signs camera, a blood pressure sensor, a pressure/hand grip sensor, an accelerometer, and/or a receiver sensor. It will be appreciated that any kind and any number of sensors may be used and that the present invention is not limited to the proposed combination of sensors. The vital signs camera may be mounted for instance on the center/top side of the rollator 10 and is directed to the person's chest. The vital signs camera acquires continuously the patient heart and respiration signals. The blood pressure sensor may be embedded into the handle of the system 10. An integrated optical sensor may be employed. The pressure/handgrip sensor may be embedded into the handles of the system 10 as well and comprise for example an air cushion embedded in the handle, or contact sensors. The accelerometer may be also integrated in the system 10. Alternatively, the accelerometer may be configured for attachment to the person by e.g. a clip to the clothing. Accordingly, the accelerometer may measure data of the person and does not require any other signals. The receiver sensor may be mounted on the center bottom side of the system 10, wherein two senders may be attached on each of the person's ankle/show. Each sender signal preferably contains a foot identifier (right or left), a time stamp, and a distance from each foot to the receiver module attached to the system 10.

The movement data 34 of the person include inter alia its speed and walk patter. An accelerometer may be employed for determining the speed. Accordingly, speed values and trends may be monitored and recorded. Feet movement sensors may determine a walk pattern. Step characteristics including time and length are required and may be determined via optical sensors. Variation of the signal may be indicative for limps. Based on these sensor data, the activity ability determination unit 72 determines a frailty state 42 of the person based on the vital sign data 32, and walking characteristics 44 of the person based on the movement data 34. The determination of activity ability may be expressed for example as a function that maps the patient frailty state 42 and the patient walking characteristics 44 to an indication of activity ability expressed as a numerical score or as a more discrete measure such as “low/medium/high”. Such a function may be also weighted average for the above input.

The activity program unit 74 in turn selects and continuously updates the walking program 50 based on a determined frailty state 42 of the person in the determined walking characteristics 44, and (optionally) based on the weather report 38, preferences 36 of the person and patient history in the following way: at a personalization step goal components will be adjusted to address current values and past trends in all of the above. In that sense a short-term goal may be represented as a delta or fraction upon the long-term goal in terms of goal components. For example, medium current value for walking characteristics combined with a decreasing trend of this parameter leads to decreased duration of walking and path difficulty. An increasing trend in walking characteristics and report on good weather leads to increased walk duration, and pace. The person is informed about the current status of the walking program and such intended changes/updates by display unit 82.

While the invention has been illustrated and described in detail in the drawings and foregoing description, such illustration and description are to be considered illustrative or exemplary and not restrictive; the invention is not limited to the disclosed embodiments.

Other variations to the disclosed embodiments may be understood and effected by those skilled in the art and practicing the claimed invention from the study of the drawings, the disclosure, and the appending claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the internet or other wired or wireless telecommunication systems.

Any reference signs in the claims should not be construed as limiting the scope.

1. System for assisting a person in walking, comprising:
a measurement unit for measuring physiological data including vital sign data and movement data of the person;
an activity ability determination unit which is configured to determine a frailty state of the person based on the vital sign data, and to determine walking characteristics of the person based on the movement data;
an activity program unit which is configured to select and continuously update a walking program based on the determined frailty state of the person and the determined walking characteristics of the person.

2. System of claim 1, further comprising an activity hardware unit for physically leading and/or supporting the person during the person's execution of the walking program, wherein the activity hardware unit is configured to physically lead and/or support the person based on the selected walking program.

3. System of claim 2, wherein at least one of the measurement unit, the activity ability determination unit and the activity program unit are comprised in the activity hardware unit.

4. System of claim 1, wherein the measurement unit for measuring vital sign data is composed of at least one physiological data sensor selected from the group consisting of a vital signs camera, a blood pressure sensor, a pressure sensor, and a galvanic skin sensor.

5. System of claim 1, wherein the measurement unit for measuring movement data is composed of at least one movement data sensor selected from the group consisting of a photosensor, camera, accelerometer, pedometer sensor, and a GPS sensor.

6. System of claim 1, further comprising an input unit for entering preferences of the person and/or a data interface for receiving weather reports, wherein the activity program unit is further configured to take into account preferences of the person and/or weather reports for selecting and continuously updating the walking program.

7. System of claim 1, further comprising a display unit.

8. System of claim 1, wherein the system is a walking assistance device or an exoskeleton.

9. Method for assisting a person in walking, comprising:
measuring physiological data including vital sign data and movement data of the person;
determining a frailty state of the person based on the vital sign data;
determining walking characteristics of the person based on the movement data;
selecting and continuously updating a walking program based on the determined frailty state of the person and the determined walking characteristics of the person.

10. Method of claim 9, further comprising the step of physically leading and/or supporting the person during the person's execution of the walking program based on the selected and continuously updated walking program.

11. Method of claim 9, wherein selecting the walking program is further based on at least one of preferences of the person, and weather reports.

12. Method of claim 9, wherein determining the frailty state of the person comprises performing a test selected from the group consisting of a heart rate test, a respiratory syncytial virus test, a blood pressure test, and a galvanic skin response test.

13. Method of claim 9, wherein determining walking characteristics of the person comprises performing a movement test selected from the group consisting of a time up & go test, tremor frequency analysis, movement pattern analysis and a functional movement screen.

14. Method of claim 9, wherein the method for assisting a person in walking is performed in real-time.

15. Computer program comprising program code means for causing a computer to carry out the steps of the method as claimed in claim 10 when said computer program is carried out on the computer.
